(19) United States
(12) Patent Application Publication
(10) Pub. No.: US 2009/0281259 A1
(43) Pub. Date: Nov. 12, 2009

(54) CATALYST FOR PROPYLENE POLYMERIZATION AND THE METHOD OF PROPYLENE POLYMERIZATION USING THE CATALYST

(75) Inventors: Joon-Ryeo Park, Daejeon (KR); Ho-Sik Chang, Daejeon (KR); Jin-Kyu Ahn, Seoul (KR); Sang-Yeol Kim, Chungcheongnam (KR)

Correspondence Address: BARLOW, JOSEPHS & HOLMES, LTD., 101 DYER STREET, 5TH FLOOR, PROVIDENCE, RI, 02903, US

(73) Assignee: SAMSUNG TOTAL PETROCHEMICALS CO., LTD., Chungcheongnam (KR)

(21) Appl. No.: 11/577,800

(22) PCT Filed: Sep. 23, 2005
(86) PCT No.: PCT/KR05/03154

§ 371 Date: Jul. 10, 2009

(30) Foreign Application Priority Data
Oct. 29, 2004 (KR) 10-2004-0087263

(51) Int. Cl. C08F 4/50; B01J 31/12

(52) U.S. Cl. 526/125.3; 502/104; 526/125.8

(57) ABSTRACT

The present invention provides a catalyst for propylene polymerization and a method for propylene polymerization using the same, specifically, a catalyst for propylene polymerization, which is prepared by reacting dialkoxy magnesium with titanium halide compound or silane halide compound and internal electron donor in the presence of an organic solvent, and a method for propylene polymerization which can produce polypropylene having 99% or more of iso-tacticity index, by mixing and reacting said catalyst, alkyl aluminum, external electron donor and propylene.

### TECHNICAL FIELD

The present invention relates to a catalyst for propylene polymerization which can produce propylene polymers having very high stereoregularity which imparts excellent mechanical rigidity and processability to the resulted formed product, and having high heat resistance owing to high melting point and high heat deformation temperature, and a method for propylene polymerization using the catalyst. Particularly, the present invention relates to a catalyst for propylene polymerization which is prepared by reacting dialkoxy magnesium with titanium halide compound or silane halide compound and internal electron donor in the presence of an organic solvent, and to a method for propylene polymerization which provides polypropylene having 99% or more of isotacticity index by mixing and reacting said catalyst, alkyl aluminum, external electron donor and propylene together.

### BACKGROUND ART

Many methods relating to a catalyst and/or an electron donor which can provide propylene polymers having high stereoregularity, have been known in this field.

U.S. Pat. No. 4,952,649, discloses a method for producing polypropylene with very high stereoregularity having 96-98% of isotacticity index (wt % of xylene insoluble), by reacting magnesium chloride dissolved in 2-ethylhexyl alcohol with titanium tetrachloride and dialkyl phthalate at −20-130° C. to form solid catalyst particles which has been recrystallized, mixing the resulted product with triethylaluminum as a cocatalyst and various alkoxy silanes as an external electron donor, and applying the resulted product to bulk polymerization of propylene.

U.S. Pat. No. 5,028,671 discloses a method for preparing polypropylene with high stereoregularity having 97-98% of isotacticity index, by using spherical solid catalyst component obtained by reacting a spherical ethanol-containing magnesium chloride carrier prepared by spray-drying, with titanium tetrachloride and dialkyl phthalate, together with triethylaluminum, as a cocatalyst and dialkyldimethoxysilane as an external electron donor.

### DISCLOSURE OF INVENTION

### Technical Problem

However, though polypropylenes provided by the above-mentioned methods may be concerned to have high stereoregularities, they have less than 99% of isotacticity index, which implies that they are not suitable for the applications requiring rather higher mechanical rigidity as well as high-speed formability.

### Technical Solution

The present invention is to solve problems of prior arts as mentioned above. Thus, the object of the present invention is to provide a catalyst for propylene polymerization, which can produce polypropylene with excellent mechanical rigidity and processability resulted from very high stereoregularity, and an excellent heat resistance, and a method for propylene polymerization.

The catalyst for propylene polymerization according to the present invention is characterized in that it is prepared by reacting dialkoxy magnesium with titanium halide compound or silane halide compound and internal electron donor, in the presence of an organic solvent.

More specifically, the catalyst for propylene polymerization according to the present invention is a porous solid catalyst particle, which can be prepared by a method comprising the steps of pre-activating dialkoxy magnesium with titanium halide compound or silane halide compound in the presence of an organic solvent, and carrying out a reaction of the resulted product from the pre-activation step with titanium compound and internal electron donor in the presence of an organic solvent.

Dialkoxy magnesium used in the preparation of the catalyst of the present invention serves as a carrier having a spherical particle shape represented by a general formula Mg(OR¹)₂, wherein R¹ is an alkyl group having C1-C6, which may be prepared by reacting magnesium metal with an alcohol, and the spherical particle shape is maintained during propylene polymerization.

The titanium halide compound which may be used in the preparation of the catalyst of the present invention is not specifically limited, however, titanium tetrachloride may be most preferably used.

The silane halide compound which may be used in the preparation of the catalyst of the present invention is not specifically limited, however, tetrachlorosilane may be most preferably used.

As for the internal electron donor used in the preparation of the catalyst of the present invention, one or more selected from the diester compounds represented by a following general formula may be used alone or as a mixture thereof, and among those, preferably aromatic diesters, more preferably phthalic acid diesters may be used:

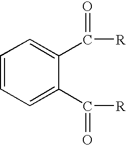

wherein, R is an alkyl group having C1-C10.

Suitable examples of the phthalic acid diesters include dimethyl phthalate, diethyl phthalate, di-n-propyl phthalate, di-isopropyl phthalate, di-n-butyl phthalate, di-isobutyl phthalate, di-n-pentyl phthalate, di(2-methylbutyl) phthalate, di(3-methylbutyl) phthalate, di-neopentyl phthalate, di-n-hexyl phthalate, di(2-methylpentyl) phthalate, di(3-methylpentyl) phthalate, di-isohexyl phthalate, di-neohexyl phthalate, di(2,3-dimethylbutyl)phthalate, di-n-heptyl phthalate, di(2-methylhexyl)phthalate, di(2-ethylpentyl)phthalate, di-isoheptyl phthalate, di-neoheptylphthalate, di-n-octyl phthalate, di(2-methylheptyl)phthalate, di-isooctyl phthalate, di(3-ethylhexyl)phthalate, di-neooctyl phthalate, di-n-nonyl phthalate, di-isononyl phthalate, di-n-decyl phthalate, di-isodecyl phthalate and the like.

As for the organic solvent used in the preparation of the catalyst of the present invention, aliphatic or aromatic hydrocarbons having C6-C12 may be used, and preferably used are saturated aliphatic or aromatic hydrocarbons having C7-C10 such as octane, nonane, decane, toluene, xylene and the like.

The preparation of the catalyst of the present invention may be carried out in a sufficiently dried reactor equipped with a stirrer, under inert gas atmosphere.

The pre-activation step of the dialkoxy magnesium with a titanium halide compound or a silane halide compound may be carried out, in a suspension of said compounds in an aliphatic or aromatic solvent, at the temperature ranged of −20-50° C., preferably of 0-30° C. At a temperature out of said range of −20-50° C., the shape of the carrier particle becomes destroyed, resulting in undesirable generation of fine particles in large quantity.

The amount of a titanium halide compound or a silane halide compound in the pre-activation step is not specifically limited. However, in terms of catalyst preparation efficiency, the amount of a titanium halide compound or a silane halide compound used is preferably 0.1-10 moles, and more preferably of 0.2-5 moles, per 1 mole of dialkoxy magnesium. The titanium halide compound or the silane halide compound is preferably fed slowly over 30 minutes to 3 hours for sufficient reaction. After the feeding completely, it is preferred to raise the temperature gradually up to 60-80° C. to complete the pre-activation reaction. When the temperature is lower than 60° C., the reaction is hardly completed, on the other hand, when it is higher than 80° C., side reactions would occur, leading to decrease in the polymerization activity of the resulted catalyst or in the stereoregularity of the resulted polymers.

The slurry type mixture obtained from the completed pre-activation step is washed once or more with an organic solvent such as toluene, and then subjected to a reaction by adding a titanium compound thereto and elevating the temperature to 90-130° C. for aging. It is not desirable to carry out the reaction in a temperature out of said range 90-130° C., since the catalyst activity and stereoregularity may be rapidly decreased. The amount of the titanium compound used in this step is not particularly limited. However, in terms of catalyst preparation efficiency, the amount of the titanium compound used is preferably 0.5-10 moles, and more preferably of 1-5 moles, per 1 mole of dialkoxy magnesium used in the previous step.

In the above reaction step, the internal electron donor is added during the temperature elevation process wherein the temperature elevation speed is not critical, and the temperature and the number of times of addition of the internal electron donor are not strictly limited. The total amount of the internal electron donor used is preferably 10-100 parts by weight, based on 100 parts by weight of dialkoxy magnesium. When the total amount of the internal electron donor used is out of said range, polymerization activity of the resulted catalyst or stereoregularity of the resulted polymers would become decreased.

The mixed slurry obtained from the completed reaction, subsequently, may be further contact-reacted with an additional titanium compound, washed with an organic solvent and dried, to produce a catalyst for propylene polymerization as a final product.

In the catalyst preparation process described above, when omitting the pre-activation step, the formation of isotactic active sites would be not sufficiently achieved in the following contact reaction owing to the effect of ethoxy groups, and when using the catalyst having insufficient active sites to propylene polymerization, the stereoregularity of the resulted propylene polymers would be decreased.

Although the pre-activation step is essential in the catalyst preparation process described above, omitting other contact reaction steps also could cause some problems such as decrease in the propylene polymerization activity of the resulted catalyst, or deterioration of stereoregularity of the resulted propylene polymers.

The catalyst of the present invention prepared by the above-described method contains magnesium, titanium, internal electron donor and halogen atom, wherein the content of each said component, though it is not particularly limited, is preferably as follows: magnesium 20-30 wt %, titanium 1-10 wt %, internal electron donor 5-20 wt % and halogen atom 40-74 wt %.

The method of propylene polymerization using the catalyst of the present invention can be carried out by polymerizing propylene in the presence of the catalyst of the present invention (i.e. main catalyst component, hereinafter, referred as component A), alkyl aluminum (i.e. co-catalyst component, hereinafter, referred as component B) and external electron donor (hereinafter, referred as component C), through bulk, slurry or gas-phase polymerization.

The component B is a compound represented by a general formula AIR²₃ wherein R² is an alkyl group having C1-C4, and specifically, for example, trimethyl aluminum, triethyl aluminum, tripropyl aluminum, tributyl aluminum, triisobutyl aluminum and the like may be used as the component B.

The component C is a compound represented by the general formula R³ₘR⁴ₙSi(OR⁵)₄₋ₘ₋ₙ, wherein R³ and R⁴ is independently an alkyl group having C1-C10, cycloalkyl or aryl; R⁵ is an alkyl having C1-C3; m is 0, 1 or 2; n is 0, 1 or 2; and m+n is 1 or 2, and specifically mentioned are, for example, n-C₃H₇Si(OCH₃)₃, (n-C₃H₇)₂Si(OCH₃)₂, i-C₃H₇ Si(OCH₃)₃, (i-C₃H₇)₂Si(OCH₃), n-C₄H₉Si(OCH₃)₃, (n-C₄H₉)₂Si(OCH₃)₂, i-C₄H₉Si(OCH₃)₃, (i-C₄H₉)₂Si(OCH₃)₂, t-C₄H₉Si(OCH₃)₃, (t-C₄H₉)₂Si(OCH₃)₂, n-C₅H₁₁Si(OCH₃)₃, (n-C₅H₁₁)₂Si(OCH₃)₂, (cyclopentyl)Si(OCH₃)₃, (cyclopentyl)₂Si(OCH₃)₂, (cyclopentyl)(CH₃)Si(OCH₃)₂, (cyclopentyl)(C₂H₅)Si(OCH₃)₂, (cyclopentyl)(C₃H₇)Si(OCH₃)₂, (cyclohexyl)Si(OCH₃)₃, (cyclohexyl)₂ Si(OCH₃)₂, (cyclohexyl)(CH₃)Si(OCH₃)₂, (cyclohexyl)(C₂H₅)Si(OCH₃)₂, (cyclohexyl)(C₃H₇)Si(OCH₃)₂, (cycloheptyl)Si(OCH₃)₃, (cycloheptyl)₂Si(OCH₃)₂, (cycloheptyl)(CH₃)Si(OCH₃)₂, (cycloheptyl)(C₂H₅)Si(OCH₃)₂, (cycloheptyl)(C₃H₇)Si(OCH₃)₂, (phenyl)Si(OCH₃)₃, (phenyl)₂Si(OCH₃)₂, n-C₃H₇Si(OC₂H₅)₃, (n-C₃H₇)₂Si(OC₂H₅)₂, i-C₃H₇Si(OC₂H₅)₃, (i-C₃H₇)₂Si(OC₂H₅)₂, n-C₄H₉Si(OC₂H₅)₃, (n-C₄H₉)₂Si(OC₂H₅)₂, i-C₄H₉Si(OC₂H₅)₃, (i-C₄H₉)₂Si(OC₂H₅)₂, t-C₄H₉Si(OC₂H₅)₃, (t-C₄H₉)₂Si(OC₂H₅)₂, n-C₅H₁₁Si(OC₂H₅)₃, (n-C₅H₁₁)₂Si(OC₂H₅)₂, (cyclopentyl)Si(OC₂H₅)₃, (cyclopentyl)₂Si(OC₂H₅)₂, (cyclopentyl)(CH₃)Si(OC₂H₅)₂, (cyclopentyl)(C₂H₅)Si(OC₂H₅)₂, (cyclopentyl)(C₃H₇)Si(OC₂H₅)₂, (cyclohexyl)Si(OC₂H₅)₃, (cyclohexyl)₂Si(OC₂H₅)₂, (cyclohexyl)(CH₃)Si(OC₂H₅)₂, (cyclohexyl)(C₂H₅)Si(OC₂H₅)₂, (cyclohexyl)(C₃H₇) Si(OC₂H₅)₂, (cycloheptyl)Si(OC₂H₅)₃, (cycloheptyl)₂Si(OC₂H₅)₂, (cycloheptyl)(CH₃) Si(OC₂H₅)₂, (cycloheptyl)(C₂H₅)Si(OC₂H₅)₂, (cycloheptyl)(C₃H₇)Si(OC₂H₅)₂, (phenyl)Si(OC₂H₅)₃, (phenyl)₂Si(OC₂H₅)₂ and the like.

In the method for propylene polymerization using the catalyst of the present invention, the amount ratio of the component B used to the component A is represented by the molar ratio of aluminum atom in the component B to titanium atom in the component A, and it is suitably in the range of 1-1000 and preferably in the range of 10-300, but the ratio may be differed depending upon the specific polymerization method used. If the amount ratio of the component B used to the component A is out of said range 1-1000, the polymerization activity becomes seriously decreased.

In the method for propylene polymerization using the catalyst of the present invention, the amount ratio of the component C to the component A is represented by the molar ratio of silicon atom in the component C to titanium atom in the component A, and it is suitably in the range of 1-200, and preferably in the range of 10-100. If the molar ratio is smaller than 1, the stereoregularity of the resulted propylene polymers becomes significantly decreased. On the other hand, if it is larger than 200, the polymerization activity of the catalyst becomes significantly decreased.

In the method for propylene polymerization using the catalyst of the present invention, the polymerization temperature is preferably 50-100° C.

According to the method for propylene polymerization using the catalyst of the present invention, it is possible to obtain polypropylene polymers having isotacticity index, which indicates stereoregularity of polymers, of 99% or more.

### MODE FOR THE INVENTION

Hereinafter, the present invention is further described in detail through examples, which have only illustrative purposes, by no means limiting the scope of the present invention.

### Example 1

### Catalyst Preparation

An 1 L glass reactor equipped with a stirrer, atmosphere of which had been sufficiently substituted with nitrogen, was charged with 150 ml of toluene and 25 g of diethoxy magnesium, prepared according to the method of Korean patent application No. 10-2003-0087194 and having spherical shape with 60□ of an average particle size, 0.86 of particle size distribution index and 0.32 g/cc of bulk density. The temperature of the reactor was maintained at 10° C. 25 ml of titanium tetrachloride was diluted into 50 ml of toluene and added to the reactor over 1 hour with stirring, and then the temperature of the reactor was raised to 60° C. with the rate of 0.5° C./1 min. After maintaining the mixture at 60° C. for 1 hour, stirring was halted so as to allow the pre-cipitation of solid products. After the precipitation was completed, the supernatant fluid was removed, 200 ml of fresh toluene was added thereto and then the resulted mixture was stirred for 15 minutes for washing. The resulted product was washed again in the same manner.

To said solid product treated with titanium tetrachloride, 150 ml of toluene was added, and then the mixture was stirred at 250 rpm while maintaining the temperature at 30° C., with addition of 50 ml of titanium tetrachloride over 1 hour at a constant speed. After the addition of titanium tetrachloride was completed, the temperature of the reactor was elevated to 110° C. over 80 minutes at a constant speed of 1° C./min. During the temperature elevation, 2.5 ml of diisobutylphthalate was further added when the temperature of the reactor reached at 40° C., 2.5 ml of diisobutylphthalate was further added when the temperature of the reactor reached at 60° C., and 2.5 ml of diisobutylphthalate was further added when the temperature of the reactor reached at 80° C. After the temperature elevation and the additions of diisobutylphthalate were completed, the temperature was maintained at 110° C. for 1 hour, then the temperature was lowered to 90° C., and stirring was halted. The supernatant fluid was removed and the resulted product was washed once, in the same manner as above, by adding 200 ml of toluene.

Then, 150 ml of toluene and 50 ml of titanium tetrachloride were added thereto, and the temperature was raised again to 110° C. and maintained for 1 hour for aging.

After completing the aging process, the resulted slurry mixture was washed twice with 200 ml of toluene for each time, and then washed 5 times with 200 ml of n-hexane at 40° C. for each time to obtain a pale-yellow solid as the catalyst component A. After drying the solid catalyst component in the nitrogen stream for 18 hours, titanium content thereof was 2.65 wt %.

[Propylene Polymerization]

Into a 2 L high-pressure stainless reactor, a small glass vial charged with 5 mg of the catalyst obtained above was loaded, and then the reactor was sufficiently substituted by nitrogen. 3 mmol of triethyl aluminum was added thereto together with 0.3 mmol of cyclohexylmethyldimethoxysilane which was served as an external electron donor. Then, 1000% m of hydrogen and 1.2 L of liquid propylene were added sequentially, and the temperature was raised to 70° C. By operating the stirrer to break the glass vial loaded in the reactor, the polymerization reaction was started. After 1 hour from the start of the polymerization reaction, the temperature of the reactor was lowered to room temperature, and unreacted propylene in the reactor was completely degassed by opening the valve to obtain the resulted prolylene polymers.

The properties of thus obtained propylene polymers were investigated, and the results were represented in Table 1.

### Example 2

Propylene polymerization was carried out in the same manner as in Example 1, except that 0.15 mmol of cyclohexylmethyldimethoxysilane was used as an external electron donor.

The properties of the obtained polypropylene polymers were investigated and the results were represented in Table 1.

### Example 3

Propylene polymerization was carried out in the same manner as in Example 1, except that the amount of hydrogen used was 5,000 ml.

The properties of the obtained polypropylene polymers were investigated and the results were represented in Table 1.

### Example 4

Propylene polymerization was carried out in the same manner as in Example 1, except that 0.3 mmol of dicyclopentyldimethoxysilane was used as an external electron donor.

The properties of the obtained polypropylene polymers were investigated and the results were represented in Table 1.

### Example 5

Propylene polymerization was carried out in the same manner as in Example 1, except that 0.3 mmol of dicyclopentyldimethoxysilane was used as an external electron donor, and the amount of hydrogen used was 5,000 ml.

### Example 6

Propylene polymerization was carried out in the same manner as in Example 1, except that 0.3 mmol of diisopropyldimethoxysilane was used as an external electron donor.

The properties of the obtained polypropylene polymers were investigated and the results were represented in Table 1.

### Example 7

Propylene polymerization was carried out in the same manner as in Example 1, except that 0.3 mmol of diisopropyldimethoxysilane was used as an external electron donor, and the amount of hydrogen used was 5,000 ml.

The properties of the obtained polypropylene polymers were investigated and the results were represented in Table 1.

### Comparative Example 1

Propylene polymerization was carried out in the same manner as in Example 1, except that the pre-activation step in which dialkoxy magnesium was contacted with titanium tetrachloride in the presence of an organic solvent, was omitted.

The properties of the obtained polypropylene polymers were investigated and the results were represented in Table 1.

### Comparative Example 2

Propylene polymerization was carried out in the same manner as in Comparative Example 1, except that 0.3 mmol of dicyclopentyldimethoxysilane was used as an external electron donor.

The properties of the obtained polypropylene polymers were investigated and the results were represented in Table 1.

### Comparative Example 3

Propylene polymerization was carried out in the same manner as in Comparative Example 1, except that 0.3 mmol of diisopropyldimethoxysilane was used as an external electron donor.

The properties of the obtained polypropylene polymers were investigated and the results were represented in Table 1.

The catalyst activity, stereoregularity, melt flow rate and melting point were determined as follows:

\textcircled{1} Catalyst activity (kg/g-cat):

amount of the resulted polymers (kg)÷amount of the catalyst used (g)

\textcircled{2} Isotacticity index: weight % of the insolubles crystallized and precipitated from mixed xylene

\textcircled{3} Melt flow rate (MFR): measured at 230° C., under the load of 2.16 kg, according to ASTM D1238

\textcircled{4} Melting point (Tm): measured with DSC at the temperature elevation speed of 10° C./min.

TABLE 1

| | External electron | Hydrogen | Catalyst activity | Isotacticity | Melt flow | Melting |
|---|---|---|---|---|---|---|
| | donor* (mmol) | (ml) | (kg/g-cat) | index(%) | rate (MFR) | point(° C. ?) |
| Example 1 | CHMDMS 0.30 | 1000 | 45.4 | 98.9 | 8.1 | 163.2 |
| Example 2 | CHMDMS 0.15 | 1000 | 47.8 | 98.5 | 8.8 | 162.7 |
| Example 3 | CHMDMS 0.30 | 5000 | 51.2 | 98.7 | 51.8 | 163.1 |
| Example 4 | DCPDMS 0.30 | 1000 | 55.3 | 99.4 | 2.8 | 164.3 |
| Example 5 | DCPDMS 0.30 | 5000 | 57.6 | 99.2 | 22.7 | 163.6 |
| Example 6 | DIPDMS 0.30 | 1000 | 53.1 | 99.0 | 4.1 | 163.4 |
| Example 7 | DIPDMS 0.30 | 5000 | 55.8 | 98.9 | 39.7 | 162.2 |
| Com. | CHMDMS 0.30 | 1000 | 42.4 | 97.9 | 8.9 | 160.7 |
| example 1 | | | | | | |
| Com. | DCPDMS 0.30 | 1000 | 48.9 | 98.5 | 3.1 | 161.8 |
| example 2 | | | | | | |
| Com. | DIPDMS 0.30 | 1000 | 48.5 | 98.2 | 4.2 | 161.8 |
| example 3 | | | | | | |

*CHMDMS; Cyclohexylmethyldimethoxysilane
DCPDMS; Dicyclopentyldimethoxysilane
DIPDMS; Diisopropyldimethoxysilane

As seen from above Table 1, the propylene polymers obtained in Examples 1-7 wherein the catalyst for propylene polymerization was prepared by the method comprising the pre-activation step of dialkoxy magnesium with a titanium halide compound in the presence of an organic solvent, according to the present invention, showed higher isotacticity index, indicating the improvement of the stereoregularity of the polymer, and significantly higher melting point, indicating the improvement of the heat resistance, than those of Comparative examples 1-3 wherein the pre-activation step was omitted.

### INDUSTRIAL APPLICABILITY

The catalyst for propylene polymerization of the present invention can provide highly stereoregular propylene polymers with high yield, by being used together with alkyl aluminum and external electron donor to propylene polymerization. The propylene polymers obtained from the method according to the present invention has good melt flowability as well as flexural strength and heat resistance, thereby having superior high-speed formability and smooth surface of the resulted formed article.

1. A catalyst for propylene polymerization prepared by a method comprising the steps of pre-activating dialkoxy magnesium with titanium halide compound or silane halide compound in the presence of an organic solvent, and carrying out a reaction of the resulted product from the pre-activation step with titanium compound and internal electron donor in the presence of an organic solvent.

2. The catalyst for propylene polymerization according to claim 1, wherein the dialkoxy magnesium is a spherical particle represented by a formula Mg(OR), wherein R is an alkyl group having C1-C6, and prepared by reacting magnesium metal with an alcohol.

3. The catalyst for propylene polymerization according to claim 1, wherein the titanium halide compound is titanium tetrachloride or the silane halide compound is tetrachlorosilane.

4. The catalyst for propylene polymerization according to claim 1, wherein the titanium halide compound is titanium tetrachloride or the silane halide compound is tetrachlorosilane 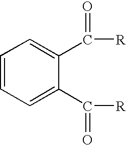
wherein, R is an alkyl group having C1-C10.

5. The catalyst for propylene polymerization according to claim 1, wherein the organic solvent is aliphatic or aromatic hydrocarbon having C6-C12.

6. The catalyst for propylene polymerization according to claim 1, wherein the pre-activation step of dialkoxy magnesium with titanium halide compound or silane halide compound is carried out in a suspension of the dialkoxy magnesium and the titanium halide compound or the silane halide compound in the organic solvent, at the temperature ranged of −20-50° C.

7. The catalyst for propylene polymerization according to claim 1, wherein the reaction of the resulted product from the pre-activation step with titanium compound and internal electron donor is carried out at the temperature ranged of 90-130° C.

8. The catalyst for propylene polymerization according to claim 1, wherein the amount of the internal electron donor is 10-100 parts by weight, based on 100 parts by weight of the dialkoxy magnesium.

9. The catalyst for propylene polymerization according to claim 1, prepared by a method wherein the mixed slurry obtained from the reaction of the resulted product from the pre-activation step with titanium compound and internal electron donor in the presence of an organic solvent, is further contact-reacted with an additional titanium compound.

10. A method for propylene polymerization wherein the propylene is polymerized in the presence of a catalyst prepared by a method comprising the steps of pre-activating dialkoxy magnesium with titanium halide compound or silane halide compound in the presence of an organic solvent and carrying out a reaction of the resulted product from the pre-activation step with titanium compound and internal electron donor in the presence of an organic solvent, and further in the presence of alkyl aluminum and external electron donor.

11. The method for propylene polymerization according to claim 10, wherein the alkyl aluminum is trialkyl aluminum represented by a general formula AIR, wherein R is an alkyl group having C1-C4.

12. The method for propylene polymerization according to claim 10, wherein the external electron donor is compound represented by the general formula R³ₘR⁴ₙ Si(OR⁵)₄₋ₘ₋ₙ, wherein R³ and R⁴ is independently an alkyl group having C1-C 10 cycloalkyl or aryl; R⁵ is an alkyl having C₁-C₃; m is 0, 1 or 2; n is 0, 1 or 2; and m+n is 1 or 2.

13. The method for propylene polymerization according to claim 10, wherein the amount ratio of the alkyl aluminum to the catalyst is in the range of 1-1000, as a molar ratio of aluminum atom in the alkyl aluminum to titanium atom in the catalyst.

14. The method for propylene polymerization according to claim 12, wherein the amount ratio of the external electron donor to the catalyst is in the range of 1-200, as a molar ratio of silicon atom in the external electron donor to titanium atom in the catalyst.

15. The method for propylene polymerization according to claim 10 wherein the dialkoxy magnesium is a spherical particle represented by a formula Mg(OR), wherein R is an alkyl group having C1-C6, and prepared by reacting magnesium metal with an alcohol.

16. The method for propylene polymerization according to claim 10 wherein the titanium halide compound is titanium tetrachloride or the silane halide compound is tetrachlorosilane.

17. The method for propylene polymerization according to claim 10, wherein the titanium halide compound is titanium tetrachloride or the silane halide compound is tetrachlorosilane 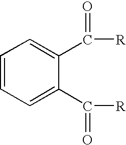
wherein, R is an alkyl group having C1-C10.

18. The method for propylene polymerization according to claim 10, wherein the organic solvent is aliphatic or aromatic hydrocarbon having C6-C12.

19. The method for propylene polymerization according to claim 10, wherein the pre-activation step of dialkoxy magnesium with titanium halide compound or silane halide compound is carried out in a suspension of the dialkoxy magnesium and the titanium halide compound or the silane halide compound in the organic solvent, at the temperature ranged of −20-50° C.

20. The method for propylene polymerization according to claim 10, wherein the reaction of the resulted product from the pre-activation step with titanium compound and internal electron donor is carried out at the temperature ranged of 90-130° C.

21. The method for propylene polymerization according to claim 10, wherein the amount of the internal electron donor is 10-100 parts by weight, based on 100 parts by weight of the dialkoxy magnesium.

22. The method for propylene polymerization according to claim 10, prepared by a method wherein the mixed slurry obtained from the reaction of the resulted product from the pre-activation step with titanium compound and internal electron donor in the presence of an organic solvent, is further contact-reacted with an additional titanium compound.
